(19) United States
(12) Patent Application Publication
(10) Pub. No.: US 2024/0052513 A1
(43) Pub. Date: Feb. 15, 2024

(54) ELECTROLYTIC COPPER FOIL, A METHOD FOR MANUFACTURING THE SAME, AND ARTICLES MADE THEREFROM

(71) Applicant: DUPONT ELECTRONICS, INC., Wilmington, DE (US)

(72) Inventor: SHIH-CHING LIN, HSINCHU (TW)

(21) Appl. No.: 18/343,029

(22) Filed: Jun. 28, 2023

Related U.S. Application Data
(60) Provisional application No. 63/396,009, filed on Aug. 8, 2022.
(60) Provisional application No. 63/488,939, filed on Mar. 7, 2023.

(51) Int. Cl. H01M 4/66; C25D 3/38; C25D 7/06; C25D 21/02; C25D 21/12

(52) U.S. Cl. CPC H01M 4/661; C25D 3/38; C25D 7/0614; C25D 21/02; C25D 21/12

(57) ABSTRACT

Disclosed are electrolytic copper foils, characterized in that: an electrodeposited surface of the electrolytic copper foil has an average surface roughness (S_{z}) of 3.50 μm or less; the electrolytic copper foil has a twin grain boundary ratio of 35% or less, or a total grain boundary density of 3.50 μm⁻¹ or more after heat treatment at 200° C. for 2 hours; the electrolytic copper foil is manufactured by electrodepositing in an electrolytic solution; and the electrolytic solution comprises 0.01 ppm to 25.0 ppm of chloride ion and 0.01 ppm to 75.0 ppm of an additive. Also disclosed are methods of manufacturing the electrolytic copper foils, and articles made therefrom. The articles include negative electrode current collectors of lithium-ion batteries or electrical double-layer capacitors, resin coated coppers, copper clad laminates, flexible copper clad laminates, various types of printed circuit boards, and the like.

### FIELD OF THE DISCLOSURE

The present invention relates to an electrolytic copper foil having an average surface roughness (S_{z}) of a precipitation surface of 3.50 μm or less, a low twin grain boundary ratio or a high total grain boundary density, and fine grain and high tensile strength. The present invention also relates to a method of manufacturing the electrolytic copper foil, and articles made therefrom.

### BACKGROUND OF THE DISCLOSURE

At present, all electric vehicles are committed to improving endurance, and the mainstream method is to increase the unit capacity of lithium-ion battery cells. There are several ways to increase the capacitance, and the simplest, low-risk methods includes two methods: (1) reducing the thickness of the copper foil of the negative electrode current collector, and (2) replacing the graphite-based material of the negative electrode with a silicon material. The benefit of replacing graphite with silicon is that the theoretical energy density of silicon materials is as high as 4200 mAh/g, about 10 times that of graphite-based materials.

However, when using the first solution, that is, reducing the thickness of the copper foil to increase the energy density, the copper foil must have high tensile strength in order to reduce the thickness while still being able to carry the negative electrode material and survive processing without breaking. Regarding the second solution, although the theoretical energy density of silicon materials is 10 times that of graphite, the volume expansion and contraction of the silicon material due to the intercalation of lithium ions is also greater than that of the graphite material during the charging and discharging process. When using silicon material as the negative electrode material, it is still necessary to use copper foil with high tensile strength to suppress excessive expansion, to avoid current collector rupture and battery failure. In order to improve the battery life and capacity of electric vehicles, no matter which of the these solutions is used to increase the energy density of the battery, it is necessary to use an electrolytic copper foil with high tensile strength and thermal stability.

Taiwan Patent Publications TW1696727B and TW1707062B disclose manufacturing methods of high-strength electrolytic copper foil, mainly using a high proportion of nano-twins to achieve the purpose of strengthening the copper foil. However, the current density applied during electroplating by these two manufacturing methods is relatively low, and it is difficult to carry out industrial mass production. Therefore, there is still a lack of industrialized high-strength copper foil on the market to solve the current problem of increasing the energy density of thin circuit boards and battery cells. Based on solving these problems in the industry, the present invention proposes a method for industrially mass-producing high-strength electrolytic copper foil.

### BRIEF DESCRIPTION OF THE DRAWINGS

FIG. 1 shows a flow chart of the present invention for manufacturing electrolytic copper foil.

### DETAILED DESCRIPTION

Unless otherwise indicated, all publications, patent applications, patents, and other references mentioned herein are hereby expressly incorporated by reference in their entirety.

Unless defined otherwise, all technical and scientific terms used herein have the same meaning as commonly understood by one of ordinary skill in the art to which this invention belongs. In case of conflict, the present specification, including definitions, will control.

Unless otherwise stated, all percentages, parts, ratios, etc. are by weight.

As used herein, the term “made from” is synonymous with “comprising”. As used herein, the terms “comprises”, “comprising”, “includes”, “including”, “has”, “having”, “containing “contains” or “containing” or any other variation thereof is intended to cover a non-exclusive inclusion. For example, a composition, process, method, article, or device that includes a list of elements is not necessarily limited to those elements, but may include other elements not specifically listed or inherent to such composition, process, method, article, or device.

The linking phrase “consisting of” excludes any unspecified element, step or component. If in a claim, such a phrase will make the claim closed so that it does not contain material other than those described, except for impurities normally associated therewith. When the phrase “consisting of” appears in a clause that is the body of a claim, rather than immediately following the preamble, it restricts only the elements stated in said clause; other elements are not excluded from the claim as a whole. The conjunction phrase “consisting essentially of” is used to define a composition, method, or apparatus that includes materials, steps, features, components, or elements in addition to those literally discussed, provided that such additional materials, The steps, features, components, or elements do not materially affect one or more of the basic and novel characteristics of the claimed invention. The term “consisting essentially of” is intermediate between “comprising” and “consisting of”. The term “comprising” is intended to include the embodiments covered by the terms “consisting essentially of” and “consisting of”. Similarly, the term “consisting essentially of” is intended to include embodiments covered by the term “consisting of”.

When amounts, concentrations, or other values or parameters are given in terms of ranges, preferred ranges, or a series of upper preferred values and lower preferred values, it should be understood that all ranges are formed by any pairing of the value for any upper or preferred value of the range, with any lower or preferred value of the range, whether or not that range is individually disclosed. For example, when a range of “1 to 5” is recited, the recited range should be construed to include “1 to 4”, “1 to 3”, “1 to 2”, “1 to 2 and 4 to 5”, “1 to 3 and 5” and other ranges. When a numerical range is described herein, unless otherwise stated, that range is intended to include its endpoints, and all integers and fractions within the range. When the term “about” is used in describing a value or endpoint of a range, the present disclosure should be understood to include the specific value or endpoint referred to.

In addition, unless there is an explicit statement to the contrary, “or” refers to an inclusive “or” rather than an exclusive “or”. For example, the condition A “or” B is satisfied by any of the following: A is true (or exists) and B is false (or does not exist), A is false (or does not exist) and B is true (or exists), and both A and B are true (or exist).

As used herein, the term “hydrocarbyl” refers to an organic compound having at least one carbon atom and at least one hydrogen atom, optionally substituted by one or more substituents where indicated; the term “alkyl” refers to straight-chain or branched saturated hydrocarbons having the indicated number of carbon atoms and having a bond of 1 valence; for example methyl, ethyl, n-propyl, isopropyl, n-butyl, isobutyl, sec-butyl, and tert-butyl, etc. “Alkylene” refers to an alkyl group having a divalent bond. “Cycloalkyl” means a monovalent group having one or more saturated rings in which all ring members are carbon; examples include cyclopropyl, cyclobutyl, cyclopentyl, and cyclohexyl; “Cycloalkylene” refers to a cycloalkyl group having a divalent bond. “Aryl” means a monovalent aromatic monocyclic or fused ring group polycyclic ring system and may include groups having an aromatic ring fused to at least one cycloalkyl group; for example phenyl, biphenyl, terphenyl, naphthyl, binaphthyl, etc. “Arylenyl” refers to an aryl group having a divalent bond. The total number of carbon atoms in a substituent group is indicated by the “Ci-Cj” prefix; for example, C1-C6 alkyl refers to methyl, ethyl, and the various propyl, butyl, pentyl, and hexyl isomers. The term “optionally substituted” is used interchangeably with the words “substituted or unsubstituted” or with the term “(un)substituted”. The expression “optionally substituted with 1 to 4 substituents” means that no substituents are present (i.e., unsubstituted) or 1, 2, 3, or 4 substituents are present (limited by available bond number of knot positions). Unless otherwise indicated, an optionally substituted group may have one substituent at each substitutable position of the group, and each substitution is independent of the other.

The embodiments of the present invention include any embodiments described herein, which can be combined in any way, and the description of variables in the embodiments not only relate to the composite material of the present invention, but also relates to products made therefrom.

The present invention is described in detail below.

The present invention provides an electrolytic copper foil, which is characterized in that: the average surface roughness (S_{z}) of the electrodeposited surface of the electrolytic copper foil is 3.50 μm or less; after heat treatment at 200° C. for 2 hours, the electrolytic copper foil has a twin grain boundary ratio of 35% or less or has a total grain boundary density (total grain boundary density) of 3.50 μm⁻¹ or more; the electrolytic copper foil is made by electrodeposition in an electrolytic solution; and the electrolytic solution includes chloride ions in a range of from about 0.01 ppm to about 25.0 ppm and additives in a range of from about 0.01 ppm to about 75.0 ppm.

Considering that one of the purposes of the present invention is to provide a negative electrode current collector suitable for lithium-ion batteries, after the high-pressure processing, if the surface roughness of its precipitation surface is too large, the electrolytic copper foil can react with the negative electrode, resulting in fractures at the interface between layers. The surface roughness used in this specification and the scope of the patent application is to measure the roughness of the electrodeposited surface of the electrolytic copper foil of the present invention with a laser scanning microscope, and use “S_{z}” as the standard for comparison.

In one embodiment, at normal temperature, the average surface roughness (S_{z}) of the electrodeposited surface of the electrolytic copper foil is 3.50 μm or less; or 3.25 μm or less; or 3.00 μm or less; or 2.75 μm or less.

In another embodiment, after heat treatment at 200° C. for 2 hours, the average surface roughness (S_{z}) of the electrodeposited surface of the electrolytic copper foil is 3.50 μm or less; or 3.25 μm or less; or 3.00 μm or less; or 2.75 μm or less.

On the other hand, another object of the present invention is to provide a thin and high-strength electrolytic copper foil to meet the current needs of fine circuit boards and improve battery energy density. The higher the strength of the copper foil, the less likely it is to deform and wrinkle. If two copper foils have the same tensile strength, the thicker copper foil will have higher strength. Because the strength of copper foil is calculated by the following relationship:

Strength (kgf/mm)=[tensile strength (kgf/mm²)]×[thickness (mm)]

If the two copper foils have the same thickness, the copper foil with higher tensile strength will have higher strength. If the thickness of a copper foil is reduced, in order to maintain the strength of the copper foil, the tensile strength of the copper foil must be increased.

In one embodiment, at normal temperature, the tensile strength of the electrolytic copper foil is about 40 kgf/mm² or more; or about 45 kgf/mm² or more; or about 50 kgf/mm² or more; or about 55 kgf/mm² or more.

In another embodiment, after heat treatment at 200° C. for 2 hours, the tensile strength of the electrolytic copper foil is about 35 kgf/mm² or more; or about 40 kgf/mm² or more or about 45 kgf/mm² or more; or about 50 kgf/mm² or more.

In one embodiment, the electrolytic copper foil of the present invention has both high tensile strength and high thermal stability.

Electron backscatter diffraction (EBSD) was used to analyze the microstructure of the electrolytic copper foil. At room temperature, the ratio of twin grain boundaries of the electrolytic copper foil crystal is about 35% or less. At the same time, after heat treatment at 200° C. for 2 hours, the ratio of twin grain boundaries of the electrolytic copper foil is also about 35% or less. In addition, whether at room temperature or after heat treatment at 200° C. for 2 hours, the average grain size of the electrolytic copper foil crystals is about 1.50 μm or less.

After heat treatment at 200° C. for 2 hours, the total grain boundary density (TGBD) of the electrolytic copper foil is about 3.50 μm⁻¹ or more. Meanwhile, after heat treatment at 200° C. for 2 hours, the electrolytic copper foil has a high-angle grain boundary density (HGBD) of about 3.00 μm⁻¹ or more, and/or a low-angle grain boundary density (LGBD) of about 0.10 μm⁻¹ or more. In addition, the ratio of the high-angle grain boundary density (HGBD) to the low-angle grain boundary density (LGBD) of the electrolytic copper foil is less than 30 after heat treatment at 200° C. for 2 hours.

In one embodiment, after heat treatment at 200° C. for 2 hours, the twin grain boundary ratio of the electrolytic copper foil is about 35% or less; or about 30% or less; or about 25% or less.

In one embodiment, after heat treatment at 200° C. for 2 hours, the average grain size of the electrolytic copper foil is about 1.50 μm or less; or about 1.25 μm or less; or about 1.00 μm or less.

In one embodiment, after heat treatment at 200° C. for 2 hours, the total grain boundary density of the electrolytic copper foil is about 3.50 μm⁻¹ or more; or about 4.50 μm⁻¹ or more; or about 5.50 μm⁻¹ or more.

In one embodiment, after heat treatment at 200° C. for 2 hours, the high-angle grain boundary density of the electrolytic copper foil is about 3.00 μm⁻¹ or more; or about 4.00 μm⁻¹ or more; or about 5.00 μm⁻¹ or more.

In one embodiment, after heat treatment at 200° C. for 2 hours, the low-angle grain boundary density of the electrolytic copper foil is about 0.10 μm⁻¹ or more; or about 0.20 μm⁻¹ or more; or about 0.30 μm⁻¹ or more.

In one embodiment, after heat treatment at 200° C. for 2 hours, the ratio of the high-angle grain boundary density (HGBD) to the low-angle grain boundary density (LGBD) of the electrolytic copper foil is less than 30; or less than 25; or less than 20.

Since the electrolytic copper foil of the present invention has high strength and thermal stability, it is easy to produce a copper foil with an extremely thin thickness, that is, a thickness of 20 μm or less. In an embodiment, the thickness of the electrolytic copper foil is about 2 μm to about 18 μm; or about 4 μm to about 15 μm; or about 6 μm to about 12 μm.

Another object of the present invention is to provide a method for manufacturing the electrolytic copper foil. The method, including:
i) providing an electrolytic solution in the electrolyzer;
ii) applying electrical current to the anode plate and the rotating cathode roll spaced apart from each other in the electrolytic solution;
iii) electrodepositing copper on the rotating cathode roll; and
iv) separating the electrolytic copper foil from the cathode roll;
   Wherein, the electrolytic solution includes:
copper sulfate in a range of from about 120 g/L to about 450 g/L,
sulfuric acid in a range of from about 30 g/L to about 140 g/L.
chloride ions in a range of from about 0.01 ppm to about 25.0 ppm, and
additives in a range of from about 0.01 ppm to about 75.0 ppm.

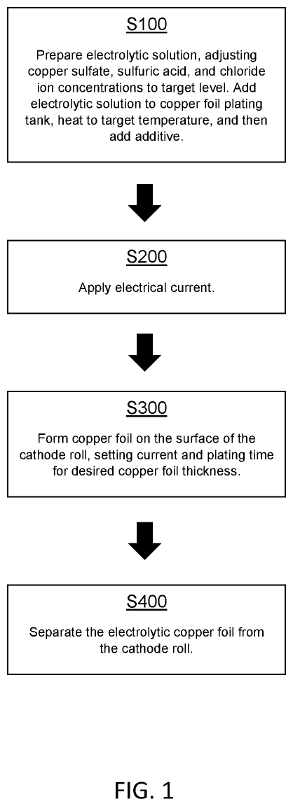

FIG. 1 is a flow chart of a method according to the present invention. With reference to FIG. 1, this method includes carrying out step S100 first: providing the electrolytic solution in an electrolyzer; then step S200: applying a current; followed by step S300: electrodepositing copper on the cathode roll; and finally step S400: separating the prepared copper foil. The control conditions of the electrodeposition include: the temperature of the electrolytic solution and the current density of the applied current. The formed copper foil has two surfaces. In the manufacturing process, the surface contacting the roller is called the “roller surface” of the copper foil; and the opposite side of the roller surface, that is, the surface facing the electrolytic solution is called the “electrodeposited surface”.

The method of the present invention has a wide operating temperature range of the electrolytic solution. The temperature of the electroplating solution is usually between about 20° C. and about 80° C., preferably between about 30° C. and about 60° C.

The method of the present invention also has a wide current operating range. Electrodeposition can be performed at an applied current density ranging from about 20 A/dm² to about 80 A/dm². Especially when electrodeposition is carried out at 60 A/dm² or more, the yield of copper foil can reach more than 16 μm/min, which meets the standard of industrial high-speed production.

In the method of the present invention, the electrolytic solution includes copper sulfate, sulfuric acid, chloride ions and additives. Copper sulfate (the source of copper ions) and sulfuric acid in the electrolytic solution are commercially available from various sources and can be used without further purification.

In one embodiment, the content of copper sulfate in the electrolytic solution is about 120 g/L to about 450 g/L based on the total volume of the electrolytic solution; or about 180 g/L to about 400 g/L; or about 240 g/L to about 350 g/L based on the total volume of the electrolytic solution.

In one embodiment, the content of sulfuric acid in the electrolytic solution, based on the total volume of the electrolytic solution, is about 30 g/L to about 140 g/L; or about 35 g/L to about 130 g/L g/L; or about 40 g/L to about 120 g/L.

The source of the chloride ion can be copper chloride or hydrochloric acid. These sources of chloride ions are commercially available and can be used without further purification.

In one embodiment, the chloride ion content in the electrolytic solution is about 0.01 ppm to about 25.0 ppm based on the total weight of the electrolytic solution; or about 0.05 ppm to about 20.0 ppm; or about 0.1 ppm to about 15.0 ppm; or about 0.5 ppm to about 10.0 ppm based on the total weight of the electrolytic solution.

The additives suitable for the electrolytic solution include gelatin, animal glue, cellulose, nitrogen-containing cationic polymer or a combination thereof. As long as the prepared electrolytic copper foil has a low twin crystal ratio, fine grains and thermal stability, there is no special limitation on the additives used. As mentioned above, regardless of whether the electrolytic copper foil is treated at room temperature or at 200° C. for 2 hours, the proportion of twin grain boundaries is less than 35%, and the average grain size is 1.50 μm or less.

In one embodiment, the additive is a nitrogen-containing cationic polymer.

In another embodiment, the nitrogen-containing cationic polymer is a reaction product of a diamine represented by formula (I) and an epoxide represented by formula (II) in a molar ratio of 1:1,

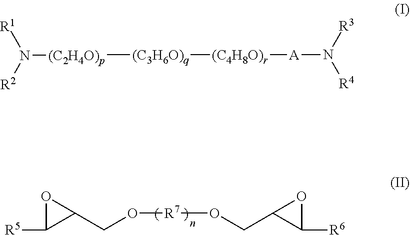

in
R¹, R², R³, R⁴, R⁵ and R⁶ are each independently H or C1-C3 alkyl;
R⁷ is a divalent linking group, including C2-C8 alkylene, C5-C10 cycloalkylene, and optionally substituted by —OH;
A is a divalent linking group, including C2-C8 alkylene, C5-C10 ring alkylene, C6-C20 arylylene or C6-C20 arylylene-C1-C10 alkylene;
p, q, and r are each independently an integer from 0 to 10; and n is an integer from 1-2.

In the method of the present invention, the amount of additive used in the electrolytic solution will depend on the particular additive selected, the concentration of copper ions in the electrolytic solution, the concentration of sulfuric acid, and the applied current density. When the total amount of additives is less than 75.0 ppm, it is beneficial to mass production operations and reduces the use of activated carbon and other filter materials. Therefore, the method of the present invention has the advantages of being beneficial to mass production and environmental protection.

In one embodiment, the additive content in the electrolytic solution is about 0.01 ppm to about 75.0 ppm; or about 0.5 ppm to about 50.0 ppm; or about 1 ppm to about 25.0 ppm based on the total weight of the electrolytic solution.

In the method of the present invention, the electrolytic solution may additionally include one or more other additives such as accelerators, inhibitors, or leveling agents. These other additives can be used in combination of one or more kinds according to the situation. Other additives are generally present in small amounts (i.e., less than 100 ppm) as long as they do not interfere with the functional properties of the electrolytic copper foil of the present invention.

The electrolytic copper foil prepared by the method of the present invention has fine and thermally stable crystal grains; at the same time, its twin grain boundary ratio is low, and is particularly suitable for preparing copper-clad laminates and flexible copper-clad laminates for micro-circuit boards, and the negative electrode current collector of lithium-ion battery or electric double layer capacitor. The electrolytic copper foil of the present invention has fine crystal grains and can provide the effect of miniaturized line width and line spacing. As long as it is properly surface treated, circuits with high density, thin line width and fine line spacing can be formed. On the other hand, since the electrolytic copper foil of the present invention has high tensile strength and thermal stability, it is easy to produce thin copper foil (thickness less than 20 μm). At the same time, because of its high strength, it can be used in combination with high-capacity silicon materials as a negative electrode collector, thereby increasing the capacity of the lithium-ion battery or electric double-layer capacitor.

Another object of the present invention is to provide articles having the electrolytic copper foil. In one embodiment, an article is a negative electrode current collector of a lithium-ion battery or an electric double layer capacitor, a resin coated copper (RCC) copper clad laminate, a flexible copper clad laminate, a rigid printed circuit board, a flexible printed circuit board or a rigid-flexible printed circuit plate.

Without further elaboration, it is believed that one skilled in the art can, using the preceding description, utilize the present invention to its fullest extent. Accordingly, the following examples should be taken as illustrations only, and not to limit the present disclosure in any way.

### EXAMPLES

The abbreviation “E” stands for “Example”, and “CE” stands for “Comparative Example”, and the numbers following it indicate the example in which the electrolytic copper foil was prepared. Examples and comparative examples are prepared and tested in a similar manner.

### Material

Gelatin: available from Singapore's Jellice Biotechnology Company Taiwan Branch (Jellice Taiwan), model FL-FCCO.

DETU: Diethylthiourea (1,3-diethyl-2-thiourea) available from Alfa Aesar Company.

SPS: sodium polydisulfide dipropane sulfonate (bis(sodium sulfopropyl) disulfide), available from HOPAX company.

PEG: polyethylene glycol (polyethylene glycol), M_{w}: about 1000, available from Alfa Aesar company.

MPS: sodium mercapto-1-propane sulfonate (sodium 3-mercapto-1-propane sulfonate), available from HOPAX company.

HEC: hydroxyethyl cellulose (hydroxyethyl cellulose), available from DAICEL company.

NCP-A: Nitrogen-containing cationic polymer, available from DuPont Electronics, trade name MICROFILL™, derived from a diamine represented by formula (I) and an epoxide represented by formula (II) at a ratio of 1:1 mole The reaction product of ratio, wherein, R¹, R², R³, R⁴, R⁵ and R⁶ are all hydrogen atoms H; p, q and r are all 0, A is C6 alkylene; and R⁷ is C4 alkylene, M_{w}: about 9000 or more.

NCP-B: Nitrogen-containing cationic polymer, available from DuPont Electronics, trade name MICROFILL™, derived from a diamine represented by formula (I) and an epoxide represented by formula (II) at a ratio of 1:1 mole. The reaction product of ratio, wherein, R¹, R², R³, R⁴, R⁵ and R⁶ are all hydrogen atoms H; p, q and r are all 0, A is C6 alkylene; and R⁷ is C6 alkylene, M_{w}: about 3000 or less.

NCP-C: Nitrogen-containing cationic polymer, available from DuPont Electronics Company, trade name MICROFILL™, derived from the diamine represented by formula (I) and the epoxide represented by formula (II) at a ratio of 1:1 mole The reaction product of ratio, wherein, R¹, R², R³, R⁴, R⁵ and R⁶ are all hydrogen atoms H; p, q and r are all 0, A is C6 alkylene; and R⁷ is C8 ring alkylene, M_{w}: about 3000 or less.

NCP-D: Nitrogen-containing cationic polymer, available from DuPont Electronics Company, trade name MICROFILL™, derived from the diamine represented by formula (I) and the epoxide represented by formula (II) at a ratio of 1:1 mole The reaction product of ratio, wherein, R¹, R², R³, R⁴, R⁵ and R⁶ are all hydrogen atoms H; p, q and r are all 0; A is C6 alkylene; and R⁷ is C4 alkylene, M_{w}: about 3000 or less.

Copper sulfate (CuSO₄) available from Taiwan Rohm and Haas Electronic Materials Company.

Sulfuric acid (H₂SO₄) available from Fangqiang Company.

Hydrochloric acid (HCl) available from Youhe Trading Company.

### Examples 1-20 and Comparative Examples 1-7

Table 1 shows the copper sulfate, sulfuric acid, chloride ion, and specific additives used to prepare electrolytic solutions.

For the rotating electrolyzer, the cathode roller is a titanium wheel, and the anode is an insoluble anode (Dimensionally Stable Anode, IrO₂/Ti), and a DC power supply is used to apply electrical current between the cathode and the anode in the electrolytic solution. As shown in Table 1, current densities of 20-80 A/dm² were used. An electrolytic solution temperature of 40° C. and a cathode rotational speed of 400 rpm were used to form electrolytic copper foils with a thicknesses in a range of 7-11 μm directly on the surface of the titanium wheel. After the electroplating was completed, the electrolytic copper foil was removed from the titanium wheel, and the samples were analyzed. Results are shown in Tables 2 and 3.

### Analytical Methods

### Evaluation of Tensile Strength and Elongation

Samples were made and tested according to the method of IPC-TM-650 2.4.18B. Samples was baked at 200° C. for 2 hours, and then tested for tensile strength and elongation.

### Evaluation of Average Surface Roughness (S_{z})

Using a laser scanning microscope (manufactured by Olympus, model: OLS-5000), with a lens of 100 times magnification and no filter, five regions of copper foil samples were inspected. According to the IS025178 method, the roughness of the area is measured in each area, and the measurement data are averaged. S_{z} is defined as the difference between the maximum peak height value and the maximum valley depth value in the measurement area.

### Measurement of Twin Boundary Ratio

EBSD samples were first polished and prepared by an ion milling cross-section polishing machine, put into an SEM (JEOL-IT800SHL) cavity with a 50-degree pre-tilted bracket, and then the stage was tilted by 20 degrees. Using high current mode, the accelerating voltage was set to 15-20 kV. EBSD data was collected by an Oxford Symmetric EBSD detector. The EBSD data collection parameters were set as follows: magnification of 3000× and acquisition step size of 0.1 μm.

AZtecCrystal software was used to analyze the EBSD data and was output to BandContrast+special grain boundary diagram. The special grain boundary map parameters were set as follows: minimum angle of 10°, copper phase, crystal axis/angle of <111>/60°, and angle deviation of 1°. The twin grain boundary and grain boundary ratio were provided in the automatically output diagram.

### Average Grain Size Measurement

EBSD samples were first prepared by polishing with an ion-milling cross-section polishing machine, placed into the SEM (JEOL-IT800SHL) cavity with a 50-degree pre-tilted bracket, and then tilted by 20 degrees. Using high current mode, the accelerating voltage was set to 15-20 kV. EBSD data was collected by an Oxford Symmetric EBSD detector. The EBSD data collection parameters were set as follows: magnification of 3000× and collection step of 0.1 μm.

For grain size analysis, EBSD data was loaded into the AZtecCrystal software, removing tiny grain effects (<0.5 μm) and ignoring the special boundary in the twin grain boundary (copper phase, <111> 60°). The software automatically outputs grain size (equivalent circle diameter, ECD) information and distribution.

### Total Grain Boundary Density Measurement

EBSD samples were first prepared by polishing with an ion-milling cross-section polishing machine, placed into the SEM (JEOL-IT800SHL) cavity with a 50-degree pre-tilted bracket, and then tilted by 20 degrees. Using high current mode, the accelerating voltage was set to 15-20 kV. EBSD data was collected by an Oxford Symmetric EBSD detector. The EBSD data collection parameters were set as follows: magnification of 3000× and collection step of 0.1 μm.

EBSD data was input into the AZtecCrystal software version 3.0 and the area to be analyzed was selected. For grain boundary analysis, the low-angle grain boundary (LGBD) angle is defined as 5 degrees to 15 degrees, and the high-angle grain boundary (HGBD) is defined as greater than 15 degrees. The total length of the low-angle grain boundaries and the total length of high-angle grain boundaries were obtained and divided by the area of the analyzed region to obtain the corresponding low-angle grain boundary density or high-angle grain boundary density. Then, the obtained low-angle grain boundary density and high-angle grain boundary density are added together to obtain the total grain boundary density (TGBD) of the sample.

From the data in Table 1 and Table 2, it can be seen that when the electrolytic solution used contains chloride ions from about 0.01 ppm to about 25.0 ppm and additives from about 0.01 ppm to about 75.0 ppm, the copper foil produced by E1 to E20 all have an average surface roughness of the precipitation plane of 3.50 μm or less (see Table 2), and a twin grain boundary ratio of 35% or less (shown in Table 2). In addition, the data in Table 2 also shows that after heat treatment at 200° C. for 2 hours, the ratio of twin grain boundaries of these copper foils is also 35% or less.

EBSD analysis photographs of the embodiment E7 and the comparative example CE1 show that their microstructures are very different. The proportion of twin grain boundaries in the copper foil of E7 was 20.2%; the proportion of twin grain boundaries in CE1 was 63.4%. Furthermore, the difference in average grain size between the two is also quite different, the former is 0.78 μm and the latter is 3.40 μm.

TABLE 1

| Ex- | Copper | Sulfuric | | | Current | Copper |
|---|---|---|---|---|---|---|
| am- | sulfate | acid | Chloride | Additives | Density | Thickness |
| ple | (g/L) | (g/L) | (ppm) | (ppm) | (A/dm²) | (μm) |
| E1 | 260 | 80 | 3 | SPS (3) | 60 | 11 |
| E2 | 260 | 80 | 3 | Gelatin (60) | 60 | 11 |
| E3 | 260 | 80 | 3 | NCP-B (3) | 60 | 11 |
| E4 | 260 | 80 | 3 | NCP-A (3) | 60 | 11 |
| E5 | 260 | 80 | 5 | NCP-A (5) | 60 | 11 |
| E6 | 260 | 80 | 7 | NCP-A (7) | 60 | 11 |
| E7 | 260 | 80 | 10 | NCP-A (10) | 60 | 11 |
| E8 | 260 | 80 | 3 | NCP-A (3) | 70 | 11 |
| E9 | 260 | 80 | 3 | NCP-A (3) | 80 | 11 |
| E10 | 260 | 80 | 3 | NCP-A (3) | 50 | 11 |
| E11 | 260 | 80 | 3 | NCP-A (3) | 40 | 11 |
| E12 | 260 | 80 | 3 | NCP-A (3) | 20 | 11 |
| E13 | 260 | 80 | 3 | NCP-A (3) | 60 | 9 |
| E14 | 260 | 80 | 3 | NCP-A (3) | 60 | 7 |
| E15 | 260 | 80 | 3 | NCP-D (3) | 60 | 11 |
| E16 | 260 | 80 | 3 | NCP-C (3) | 60 | 11 |
| E17 | 260 | 80 | 3 | NCP-A (20) | 60 | 11 |
| E18 | 300 | 80 | 3 | NCP-A (3) | 60 | 11 |
| E19 | 260 | 120 | 3 | NCP-A (3) | 60 | 11 |
| E20 | 260 | 60 | 3 | NCP-A (3) | 60 | 11 |
| CE1 | 260 | 80 | 0 | Gelatin (3) | 60 | 11 |
| CE2 | 260 | 80 | 3 | — | 60 | 11 |
| CE3 | 260 | 80 | 30 | Gelatin (20) | 60 | 11 |
| CE4 | 260 | 80 | 30 | DETU (20) | 60 | 11 |
| CE5 | 260 | 80 | 30 | SPS (5), | 60 | 11 |
| | | | | PEG(5) | | |
| CE6 | 260 | 80 | 0 | NCP-A (3) | 60 | 11 |
| CE7 | 260 | 80 | 30 | MPS (4.5), | 60 | 11 |
| | | | | HEC (4.5), | | |
| | | | | Gelatin (1) | | |

TABLE 2

| | | Twin boundary | Average grain | Tensile | Tensile | Elongation |
|---|---|---|---|---|---|---|
| | Roughness | ratio | size | strength | strength | (after |
| | S_{z} | (after 200° C.) | (after 200° C.) | (before heat) | (after 200° C.) | 200° C.) |
| Example | (μm) | (%) | (μm) | (kg/mm²) | (kg/mm²) | (%) |
| E1 | 3.30 | 32.7 | 1.15 | 49 | 40 | 1.77 |
| E2 | 3.47 | 32.4 | 0.93 | 43 | 38 | 1.53 |
| E3 | 2.97 | 25.3 | 0.88 | 54 | 48 | 1.30 |
| E4 | 3.03 | 31.2 | 0.90 | 62 | 53 | 1.59 |
| E5 | 2.91 | 28.7 | 0.85 | 64 | 55 | 2.07 |
| E6 | 2.73 | 20.5 | 0.72 | 61 | 58 | 1.65 |
| E7 | 2.84 | 20.2 | 0.78 | 60 | 59 | 1.71 |
| E8 | 2.87 | 23.7 | 0.88 | 60 | 53 | 1.81 |
| E9 | 3.27 | 19.9 | 0.80 | 63 | 49 | 1.56 |
| E10 | 3.10 | 22.4 | 0.87 | 58 | 57 | 2.21 |
| E11 | 2.38 | 28.8 | 0.87 | 59 | 57 | 2.19 |
| E12 | 3.49 | 30.8 | 0.98 | 53 | 53 | 2.13 |
| E13 | 2.54 | 22.5 | 0.85 | 62 | 50 | 1.80 |
| E14 | 2.72 | 22.1 | 0.90 | 56 | 47 | 1.62 |
| E15 | 2.68 | 23.2 | 0.88 | 63 | 54 | 1.99 |
| E16 | 2.81 | 25.1 | 0.85 | 63 | 55 | 2.28 |
| E17 | 3.08 | 27.2 | 0.95 | 54 | 48 | 2.39 |
| E18 | 2.57 | 24.3 | 0.81 | 56 | 52 | 2.31 |
| E19 | 2.73 | 22.5 | 0.78 | 54 | 54 | 2.29 |
| E20 | 2.51 | 26.2 | 0.91 | 60 | 49 | 1.83 |
| CE1 | 4.31 | 63.4 | 3.40 | 58 | 27 | 10.46 |
| CE2 | 3.24 | 50.8 | 2.09 | 51 | 25 | 3.53 |
| CE3 | 3.94 | 58.2 | 2.27 | 49 | 21 | 2.90 |
| CE4 | 7.56 | 46.7 | 1.56 | 41 | 31 | 3.01 |
| CE5 | 4.24 | 51.5 | 1.87 | 56 | 26 | 2.69 |
| CE6 | 7.63 | 70.8 | 2.77 | 48 | 22 | 3.84 |
| CE7 | 4.28 | 63.0 | 2.25 | 44 | 39 | 3.08 |

TABLE 3

| | TGBD | HGBD | LGBD | HGBD/LGBD |
|---|---|---|---|---|
| Example | (μm⁻¹) | (μm⁻¹) | (μm⁻¹) | ratio |
| E1 | 4.29 | 4.11 | 0.18 | 22.83 |
| E2 | 4.34 | 4.08 | 0.26 | 15.73 |
| E3 | 6.13 | 5.86 | 0.27 | 21.70 |
| E4 | 6.33 | 6.04 | 0.29 | 20.63 |
| E5 | 6.90 | 6.42 | 0.48 | 13.38 |
| E6 | 6.23 | 5.86 | 0.37 | 15.80 |
| E7 | 4.36 | 4.13 | 0.23 | 17.62 |
| E8 | 4.20 | 3.97 | 0.23 | 17.09 |
| E9 | 4.22 | 4.00 | 0.22 | 17.90 |
| E10 | 4.03 | 3.78 | 0.25 | 15.15 |
| E11 | 3.94 | 3.76 | 0.18 | 20.92 |
| E12 | 3.67 | 3.54 | 0.13 | 26.36 |
| E13 | 4.29 | 4.07 | 0.21 | 19.09 |
| E14 | 3.86 | 3.52 | 0.34 | 10.39 |
| E15 | 4.19 | 3.90 | 0.29 | 13.43 |
| E16 | 3.91 | 3.73 | 0.19 | 20.10 |
| E17 | 3.75 | 3.54 | 0.21 | 16.86 |
| E18 | 3.95 | 3.70 | 0.25 | 14.71 |
| E19 | 4.23 | 3.93 | 0.30 | 13.10 |
| E20 | 3.67 | 3.45 | 0.23 | 15.00 |
| CE1 | 1.26 | 1.24 | 0.02 | 59.68 |
| CE2 | 1.89 | 1.84 | 0.05 | 38.82 |
| CE3 | 1.74 | 1.72 | 0.01 | 116.78 |
| CE4 | 1.97 | 1.95 | 0.02 | 97.50 |
| CE5 | 1.29 | 1.27 | 0.02 | 63.50 |
| CE6 | 1.82 | 1.82 | 0.00 | 940.67 |
| CE7 | 1.88 | 1.87 | 0.01 | 131.22 |

Referring to the data in Table 2 and comparing the tensile strength of the copper foils of E1 to E20 and CE1 to CE7, before heating, all of the copper foils have a tensile strength of 40 kg/mm² or more. However, after heat treatment at 200° C. for 2 hours, the copper foils of E1-E20 experienced small losses in strength, with almost all of the examples maintaining their tensile strength above 40 kg/mm². By contrast, the tensile strengths of the copper foils were significantly reduced, with all of the comparative examples dropping below 40 kg/mm². For example, although the tensile strengths of CE1, CE2 and CE5 before heating all exceed 50 kg/mm², after heat treatment, the tensile strengths of these copper foils were significantly lower to below 30 kg/mm², indicating that they do not have good strength and thermal stability. Therefore, they are not suitable for the needs of lithium battery negative electrode collectors and thin circuit printed circuit boards.

From Table 3, it can be seen that the copper foils produced by E1 E20 have a total grain boundary density (TGBD) of 3.50 μm⁻¹ or more after heat treatment at 200° C. for 2 hours, a high angle grain boundary density (HGBD) of 3.00 μm⁻¹ or more, and a low angle grain boundary density (LGBD) of 0.10 μm⁻¹ or more. At the same time, the ratio of the high-angle grain boundary density to the low-angle grain boundary density (HGBD/LGBD) of the electrolytic copper foil is less than 30.

EBSD analysis photos of the copper foils of the embodiment E7 and the comparative example CE1 show that the microstructures of the two are very different. The total grain boundary density of E7 is 4.36 μm⁻¹, the high-angle grain boundary density is 4.13 μm⁻¹, and the low-angle grain boundary density is 0.23 μm⁻¹. The total grain boundary density of CE1 is 1.26 μm⁻¹, the high-angle grain boundary density is 1.24 μm⁻¹, and the low-angle grain boundary density is 0.02 μm⁻¹.

According to the method of the present invention, controlling the chloride ion content between 0.01 ppm and 25.0 ppm and adding 0.01 ppm to 75.0 ppm of additives to the electrolytic solution, while using high current density (20 to 80 A/dm²), electrolytic copper foil with low surface roughness, low twin grain boundary ratio, high total grain boundary density, high strength and thermal stability can be obtained. In addition, the electrolytic copper foil of the present invention is particularly suitable for negative electrode current collectors of lithium-ion batteries or electric double-layer capacitors, and copper-clad laminates for printed circuit boards with thin lines.

What is claimed is:

1. An electrolytic copper foil, wherein:
an average surface roughness (S_{z}) of an electrodeposited surface of the electrolytic copper foil is 3.50 μm or less;
after heat treatment at 200° C. for 2 hours, the electrolytic copper foil has: (i) a twin grain boundary ratio of 35% or less, or (ii) a total grain boundary density of 3.50 μm⁻¹ or more; and
the electrolytic copper foil is produced by electrodeposition in an electrolytic solution, wherein the electrolytic solution comprises:
chloride ions in a range of from 0.01 to 25.0 ppm; and
additives in a range of from 0.01 to 75.0 ppm.

2. The electrolytic copper foil of claim 1, wherein after heat treatment at 200° C. for 2 hours, an average grain size of the electrolytic copper foil is 1.50 μm or less.

3. The electrolytic copper foil of claim 1, wherein after heat treatment at 200° C. for 2 hours, the electrolytic copper foil has a high-angle grain boundary density of 3.00 μm⁻¹ or more, a low-angle grain boundary density of 0.10 μm⁻¹ or more, or both.

4. The electrolytic copper foil of claim 1, wherein after heat treatment at 200° C. for 2 hours, a ratio of the high-angle grain boundary density to the low-angle grain boundary density of the electrolytic copper foil is less than 30.

5. The electrolytic copper foil of claim 1, wherein after heat treatment at 200° C. for 2 hours, a tensile strength of the electrolytic copper foil is 35 kg/mm² or more.

6. The electrolytic copper foil of claim 1, wherein a thickness of the electrolytic copper foil is 20 μm or less.

7. The electrolytic copper foil of claim 1, wherein the additives in the electrolytic solution comprise a gelatin, an animal glue, a cellulose, a nitrogen-containing cationic polymer or a combination thereof.

8. The electrolytic copper foil of claim 7, wherein the additive is a nitrogen-containing cationic polymer.

9. The electrolytic copper foil of claim 8, wherein the nitrogen-containing cationic polymer is a reaction product of a diamine represented by formula (I) and an epoxide represented by formula (II) at a molar ratio of 1:1, 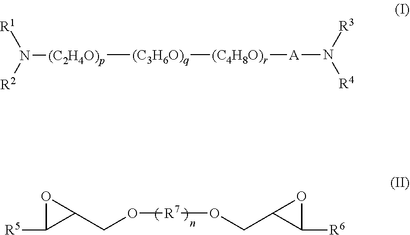
wherein:
R¹, R², R³, R⁴, R⁵ and R⁶ are each independently H or C1-C3 alkyl;
R⁷ is a divalent linking group, including C2-C8 alkylene, C5-C10 cycloalkylene, and optionally substituted by —OH;
A is a divalent linking group, including C2-C8 alkylene, C5-C10 ring alkylene, C6-C20 arylylene or C6-C20 arylylene-C1-C10 alkylene;
p, q, and r are each independently an integer from 0 to 10; and
n is an integer from 1 to 2.

10. The electrolytic copper foil of claim 1, wherein the electrolytic solution further comprises copper sulfate in a range of from 120 to 450 g/L and sulfuric acid in a range of from 30 to 140 g/L.

11. The electrolytic copper foil of claim 1, wherein the electrodeposition is performed at a current density in a range of from 20 to 80 A/dm².

12. The electrolytic copper foil of claim 1, wherein the electrodeposition is performed at an electrolytic solution temperature in a range of from 30 to 60° C.

13. A method for manufacturing the electrolytic copper foil of claim 1, comprising:
i) providing the electrolytic solution in an electrolyzer;
ii) applying an electrical current to an anode plate and a rotating cathode roll spaced apart from each other in the electrolytic solution;
iii) electrodepositing copper on the rotating cathode roll; and
iv) separating the electrolytic copper foil from the cathode roll, wherein the electrolytic solution comprises:
copper sulfate in a range of from 120 to 450 g/L;
sulfuric acid in a range of from 30 to 140 g/L;
chloride ions in a range of from 0.01 to 25.0 ppm; and
additives in a range of from 0.01 to 75.0 ppm.

14. The method of claim 13, wherein the current density of the applied current is in a range of from 20 to 80 A/dm².

15. The method of claim 13, wherein the temperature of the electrolytic solution is in the range of from 30 to 60° C.

16. The method of claim 13, wherein the additive comprises a gelatin, an animal glue, a cellulose, a nitrogen-containing cationic polymer or a combination thereof.

17. The method of claim 16, wherein the additive is a nitrogen-containing cationic Polymer, which is a reaction product of a diamine represented by formula (I) and an epoxide represented by formula (II) in a 1:1 molar ratio, 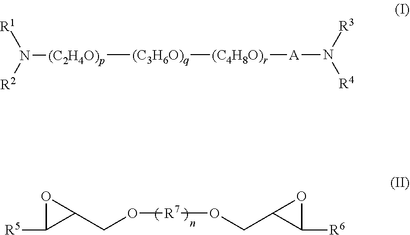
wherein:
R¹, R², R³, R⁴, R⁵ and R⁶ are each independently H or C1-C3 alkyl;
R⁷ is a divalent linking group, including C2-C8 alkylene, C5-C10 cycloalkylene, and optionally substituted by —OH;
A is a divalent linking group, including C2-C8 alkylene, C5-C10 ring alkylene, C6-C20 arylylene or C6-C20 arylylene-C1-C10 alkylene;
p, q, and r are each independently an integer from 0 to 10; and
n is an integer from 1 to 2.

18. An article comprising the electrolytic copper foil of claim 1, wherein the article is a negative electrode collector, an adhesive-backed copper foil, a copper-clad laminate, a flexible copper clad laminate, a rigid printed circuit board, a flexible printed circuit board or a rigid-flex printed circuit board.
